(19) United States
(12) Patent Application Publication
(10) Pub. No.: US 2006/0149422 A1
(43) Pub. Date: Jul. 6, 2006

(54) Air circulation control device

(76) Inventors: James Edward Dunstan, Springfield, VA (US); Steven Bress, Germantown, MD (US)

Correspondence Address: James E. Dunstan, 6105 Tobey Court, Springfield, VA, 22150, US

(21) Appl. No.: 11/027,264

(22) Filed: Dec. 30, 2004

(51) Int. Cl. G05B 13/00

(52) U.S. Cl. 700/276; 62/115

(57) ABSTRACT

An improved air circulation control device for circulation fans, such as attic and greenhouse fans, to increase their efficiency. The current invention includes a self-contained system consisting of: a power delivery device, battery, temperature sensors, humidity sensors, fan system, and computational control system (CCS). The power delivery system (such as a solar collector device) produces electrical power. The invention uses this electrical power to charge the battery. The CCS monitors the temperature and humidity of the enclosed area and the charge status of the battery, and determines when to operate the fan and at what speed. The CCS also stores historical data, and in a further embodiment, can be tied into a weather predicting system to plan ahead for the collection and use of electrical energy in the system to evacuate warm air, or reverse the process to bring warm air from the outside into the enclosed area on a cold day.

### BACKGROUND OF THE INVENTION

A. Field of the Invention

The present invention relates to the control of air circulation fans used to modify environmental conditions in structures.

B. Description of Related Art

A number of commercial solar powered attic fans are available today. All consist of three major components: 1) A photovoltaic cell to produce electricity (direct current or DC) from the sun; 2) a fan designed to circulate air; and 3) housing to contain the overall system. See e.g., http://www.bigfrogmountain.com/solaratticfandetails.html; http://www.mrsolar.com/Merchant2/merchant.mvc?Screen=CTGY&Store_Code=MSOS &Category_Code=attic (produced by BP Solar). Some systems add a thermostat to control simple on-off operations. See http://shop.altenergystore.com/itemdesc.asp?CartId=11958224OHR-EVEREST-JW32&ic=NATATTICFAN%2DSW&cc=&tpc=. All current systems available are nonetheless dependent on the sun shining at that moment to drive the fan; none incorporate a power management system or battery.

Several existing patents exist within this field. For example U.S. Pat. No. 5,878,584, Sasaki, et al., “Air conditioner with solar generator” describes a system by which a photovoltaic or other electricity producing solar panel is tied into a conventional air conditioning system for a structure by converting the DC current from the solar panel to AC current and feeding it into a preexisting electrical system. U.S. Pat. No. 5,014,770, Palmer, “Attic solar energy vehicle,” describes a system where for heating a structure using solar power to heat a liquid contained in coils in a building attic.

U.S. Pat. No. 5,725,062, Fronek, “Vehicle top solar power generator,” describes a system whereby a photovoltaic cell is mounted on a motor vehicle, and the DC energy gathered is tied into the existing electrical system of the vehicle to provide supplemental power to run electrical devices inside the vehicle such as fans. U.S. Pat. No. 6,692,130, Snow, “Solar powered heating and ventilation system for vehicle,” describes a system of mounting a photovoltaic cell on a vehicle and a series of ducts to help the vehicle maintain a comfortable temperature while unattended. The system provides power to the existing battery and electrical system to replace energy used to cool the vehicle while unattended.

Accordingly, there is a need in the art for novel systems which allow for the storage of energy at times when the temperature and humidity in an enclosed space does not require a fan to run, and effectively “time shift” that energy to a time where fan operation is demanded, but there is no current source of electricity to run the fan. Further, there is a need in the art for novel “smart” systems to store environmental data and efficiently use the energy within the system to provide optimal environmental control.

### SUMMARY OF THE INVENTION

Current air circulation fans, especially those that are “off-grid” (not tied into a structure's AC electrical system) are directly wired from the energy producing component, such as a photovoltaic cell, to the fan, making the system wholly dependent on the energy input into the system at any given point in time. If the sun is shining, the fan runs. If the sun is not shining, because it is night or it is overcast, the fan does not run. There may be many times when the fan is running, but there is no need for the fan to run because the temperature is not high enough or the air moist enough to need evacuation (e.g. early morning). Conversely, there may be times when the temperature within the enclosed space requires the fan to run, but the sun is not shining at that time (e.g. just after sunset). Finally, there may be instances in which it is slightly overcast, the collection device is producing energy, but that energy is insufficient to power the fan (e.g. below the minimum input voltage of the system). The current invention solves all of these problems by utilizing a self-contained power and control system including a battery, temperature sensors, and computational control system (CCS).

One aspect of the invention is the power system, which in one embodiment of the invention is an “off-grid” system such as a solar collector device, or windmill, which produces electrical power at all times when there is sunlight (or wind). The invention may use this electrical power to charge the battery.

Another aspect of the invention is the CCS, which monitors the temperature and/or humidity of an enclosed area through the use of one or more temperature sensors, and which may monitor other aspects of the enclosed area, and the charge status of the battery, and from that data determines when to turn the fan on and begin drawing power from the battery.

A further aspect of the invention is that the CCS controls the voltage sent to the fan. Since the fan is a direct current device, the higher the voltage used, the faster the fan turns, and the more air is evacuated from the enclosed space.

A further aspect of the invention is that the CCS may vary the speed of the fan through pulse width modulation for more precise speed control.

A further aspect of the invention is that the CCS controls the speed of the fan by providing appropriate control signals to the fan's built-in speed controller. In some cases, the speed controller may be a separate unit from the fan and CCS, yet interface with both.

A further aspect of the invention is that the CCS may come with geographic region preset switches so that “out of the box,” a user can customize the system to best suit his/her geographic location.

A further aspect of the invention is an input connection from the CCS to an external source, such as a user's PC, to allow a user to customize the CCS “out of the box” prior to installation by downloading basic geographic and climate information from a web site.

A further aspect of the invention is that the CCS may store historical data, such as time of day and temperature data throughout the day, to forward predict the need for fan operations for the rest of the day.

A further aspect of the invention is that the CCS may include a real-time clock/calendar to efficiently calculate energy usage through a day or changing seasons.

In another embodiment, the time and date may be set by a radio or Internet based atomic clock.

A further aspect of the invention is that the CCS may include learning algorithms that become “smarter” as the deployed invention operates to adapt to the particular environmental conditions in an enclosure and surrounding environment to more efficiently utilize the energy in the system to operate the fan(s). In another aspect of the invention, the fan may be reversed to bring warm air from the outside into the enclosed area on a cold day. This could occur, for example, on the first day of “thaw” after a cold spell and heavy snow, where the enclosed space is blanketed with snow, yet the outside temperature rises well above freezing.

In a further embodiment, the system may be tied into a weather predicting system to plan ahead for the collection and use of electrical energy over a period of days. For example, if today is predicted to be warm and sunny, but not too hot, but the next three days are predicted to be overcast but also warm, the system can store excess energy today for use in the next few days, even if the result is that today the temperature is allowed to drift higher than optimally desired by a user. The CCS can make the determination that a slight temperature increase today is better than very large temperature increases over the next few days. An additional aspect of this embodiment may be the ability of a user to communicate and “fine tune” the CCS for personal needs such as placing the system in “conserve” mode during days when the user is away.

### BRIEF DESCRIPTION OF THE DRAWINGS

The accompanying drawings; which are incorporated in and constitute a part of this specification, illustrate the invention and, together with the description, explain the invention. In the drawings.

FIG. 1 is a block diagram showing an embodiment of the invention.

FIG. 2 is a block diagram showing another embodiment of the invention.

FIG. 3 is a block diagram of an embodiment of the CCS unit.

FIG. 4 is a flowchart of the logic used in the invention.

### DETAILED DESCRIPTION

The following detailed description of the invention refers to the accompanying drawings. The same reference numbers in different drawings identify the same or similar elements. Also, the following detailed description does not limit the invention.

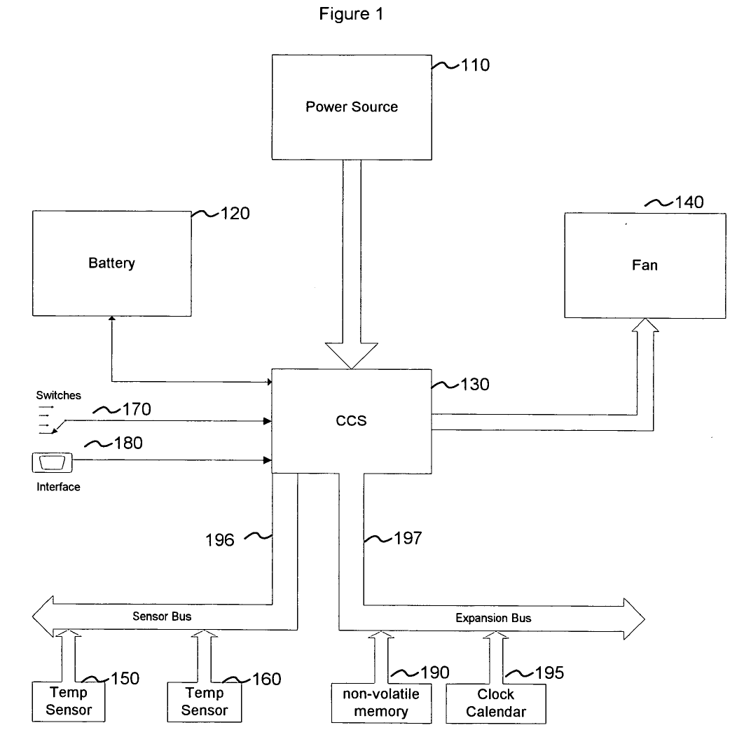

FIG. 1 is a block diagram of the basic configuration of the system. The current invention includes a power delivery device, such as a solar collector (110), battery (120), temperature sensors (150 and 160), computational control system (CCS)

(130) and fan system (140). The power delivery device (110) sends electrical power to the system. The electricity produced by the solar collector device (110) charges the battery (120). The CCS (130) performs one or more of the following functions:
a) Monitors the temperature of the enclosed area based on data collected from one or more temperature sensors and humidity sensors (150). The data link (196) between the temperature sensor (150) and the CCS (130) can be either wired or wireless;
b) Monitors the external environment based on data collected from one or more temperature sensors (160). The data link (196) between the temperature sensor (160) and the CCS (130) can be either wired or wireless;
c) Monitors the charge status of the battery (120);
d) Monitors the voltage output of the solar collection device (110)
e) Determines when to operate the fan system (140) and begin drawing power from the battery;
f) Controls both the on/off status of the fan system (140), and the speed of the fan system (140) by varying the voltage, including voltage doubling;
g) Determines the preset geographic region of the country where the system is installed based on user-defined switches set prior to installation (170);
h) Contains a hardwire interface whereby a user can program the system prior to installation (180);
i) Stores historical performance data in nonvolatile memory (190);
j) Correlates the historical performance data with an onboard real-time clock/calendar (195) to “learn” more about its operational environment. The following examples illustrate the current invention, but does not limit it. Sunrise on a day in June is 6:35 a.m. At that time the outside temperature is 78° Fahrenheit. The temperature in the enclosed space is also 78° Fahrenheit. At sunrise, sunlight begins hitting the solar panel, used as the power delivery device and it begins to transmit electricity. With current systems, the fan would begin turning, and 78° air inside the structure would be vented into the 78° air outside, wasting the energy. With the current invention, the CCS (130) would recognize that the inside and outside temperatures were identical and not turn the fan on. The energy generated during the early morning hours thus would be saved to the battery and not wasted on venting cool air. Similarly, sunset on that day is at 7:10 p.m. At that point the internal temperature is 98° Fahrenheit, and the outside temperature is 90°. With current systems, the fan would shut down at sunset. With the invention, assuming sufficient energy existed in the battery, the CCS (130) would continue to operate the fan, venting additional warm air out into the cooling early-evening environment. The cost savings in terms of home air conditioning with the invention would be substantial.

One final example bears analysis. During the hypothetical June day at 2:00 p.m. a cloud cover passes over the building, occulting the sun for a period of 30 minutes. Temperatures remain at 98°. At that point the output from the solar collecting system is reduced from 12 watts down to 3 watts. With conventional systems, 3 watts would be insufficient to sustain operation of the fan and it would stop. Worse yet, the 3 watts of energy would nonetheless be dumped into the fan system, creating heat, as the only way to dissipate the energy since the wattage is too low to turn the fan. In this scenario the overall system is now generating heat into the system rather than evacuating heat. With the invention, however, the 3 watts of energy over those 30 minutes (1.5 watt/hours), would be channeled to the battery system, and available to run the fan either for 15 minutes out of the 30 (assuming a 6 watt minimum input to the fan was necessary), or for all 30 minutes if the CCS (130) determined that the battery had enough energy to run the fan during that entire system.

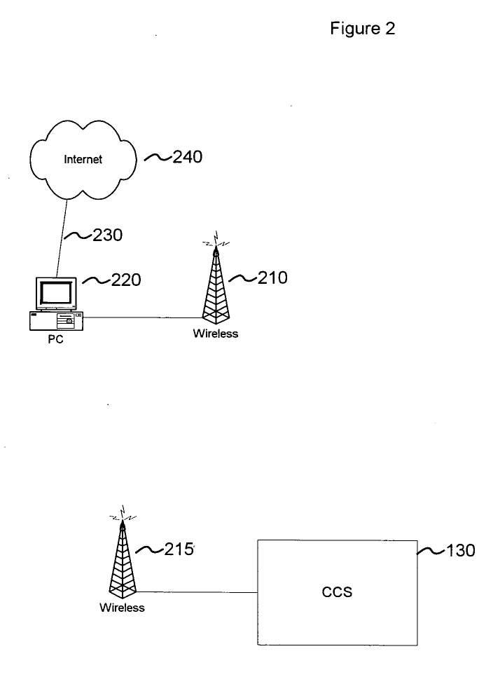

FIG. 2 depicts a further embodiment of the invention. In addition to the components depicted in FIG. 1, FIG. 2 also adds a two-way wireless communications link (210) that links the CCS (130) to a standard PC (220) with an Internet connection (230). The PC (220) retrieves weather prediction information from any of a number of existing web sites (240). This information is used by the CCS (130) to plan power management for days into the future. By way of example, in no way meant to limit the claims of this invention, the CCS (130) could pull information from a web-based weather service (240) to determine that the temperature over the next three days was going to be clear with maximum temperatures of 100°, 92°, and 85°, respectively, indicating a cooling trend. The CCS could then determine that it could expend most of the stored energy in the battery on day one, and the remaining stored energy in day two, to achieve maximum cooling on those days, because less energy would be required on the third, and coolest days. Conversely, if the situation was reversed, and the weather forecast was for a warming trend, the CCS would begin to store excess energy in days one and two for use on the hottest of the three days.

Further, a user of the PC (220), using a wireless connection (210) could interact with the CCS (130) with a matching wireless connection (215) to program it based on the users needs after the system in installed. By way of example, and in no way intended to limit the claims of the invention, a user could tell the CCS to go into “conserve” mode for Friday, Saturday, and Sunday, if the user is going to be away. In that way, the system would choose to store the maximum energy possible and allow the temperature in the interior environment to build up while the user is away. Before the user returns on Monday, the CCS would go into “maximum cooling” mode to provide the best cooling for the period when the user is home. Such user-defined modes could span a single day, multiple days, or weeks, further lending to the overall efficiency of the system.

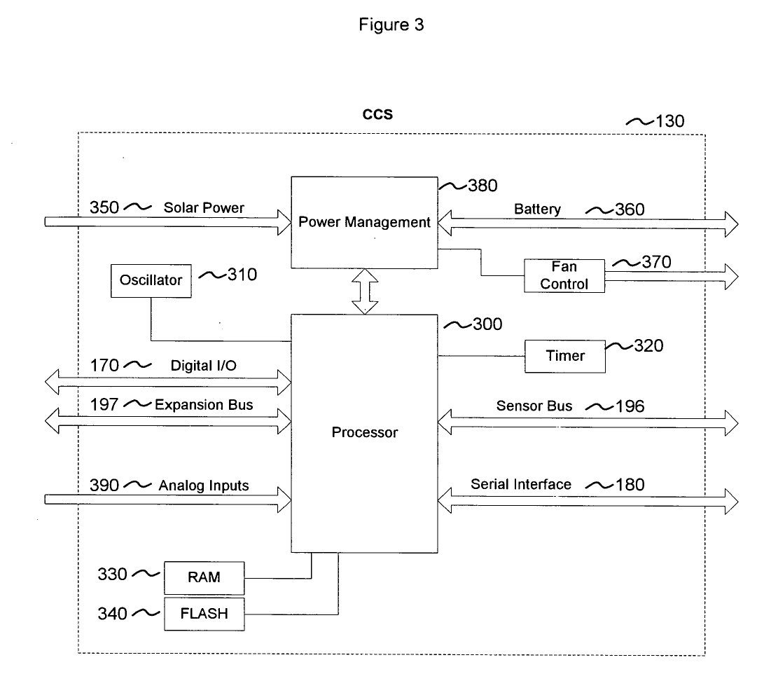

FIG. 3 shows an embodiment of the CCS unit.

Input power, typically through a solar cell array (110), is fed into the Power Management system (380) through the Solar Power bus (350). The Power Management system is responsible for controlling the high power portions of the Invention. This includes charging and monitoring the Battery (120) through the battery power bus (360) and controlling the speed, and in some embodiments, the direction of the cooling fan (140). The Fan Control unit (370) is the actual fan interface that takes control information from the Power Management system and translates it into the specific signals required to drive the fan. In the preferred embodiment, it can also return information from the fan such as RPM and airflow back to the Power Management system and/or the Processor (300).

Like most modern computer systems, an oscillator (310) is necessary to control the speed of the processor. A hardware Timer circuit (320) is used so that elapsed time can be known without having to perform any programming tricks to estimate time. Serial Interface bus (180) produces RS-232 compatible signals that may be used to communicate with an external device.

The Expansion Bus (197) and Sensor Bus (196) are 2 wire serial busses. In the preferred embodiment, these serial busses are compatible with the I²C protocol, original developed by Philips Electronics. These busses allow for the easy connection of additional devices to the system, such as additional memory and sensors. One such sensor is a temperature sensor from Microchip, the TCN75. This device allows a processor using an I²C compatible bus to directly read the temperature without the additional step of an Analog to Digital conversion.

Microchip of Chandler, Ariz., manufactures a microcontroller that incorporates many of the functions of the CCS Unit. The PIC16LF88 has numerous peripherals built in that directly map into the functions described for the CCS. It uses an internal oscillator (310) to clock its processor. A small amount of RAM (330) and non-volatile FLASH memory (340) are built into the chip. In addition, the PIC16LF88 has a built-in 10 bit Analog to Digital (A/D) converter along with an analog multiplexer allowing the processor to directly read analog signals (390) in addition to a number of general purpose Digital I/O pins (170) that may be used as directed under program control. The 1²C serial interface bus control required for the Sensor Bus and the Expansion Bus is created under software control and implemented using a pair of the general purpose I/O pins for each bus.

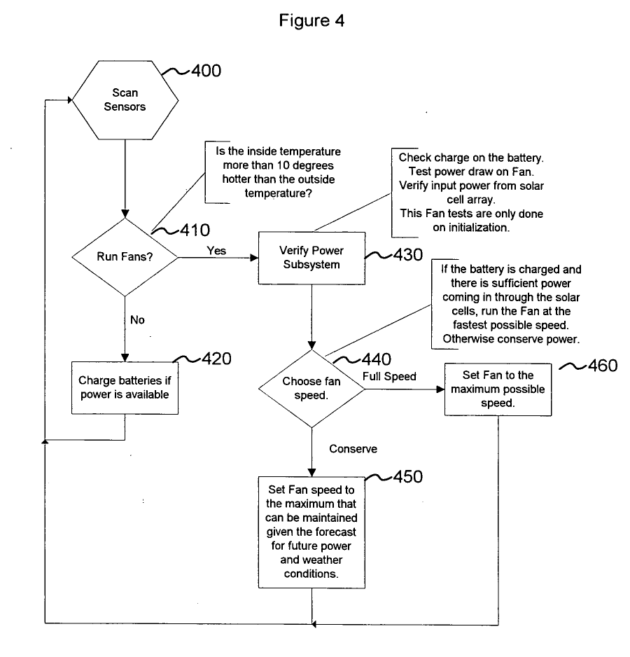

FIG. 4 shows the logic flow of the CCS Unit (130) in the preferred embodiment. The sensors are scanned (400) to determine the current state of the unit and its environment. Based on the data from the temperature sensors, a decision (410) is made as to whether the Fan (140) should be run. If the outside temperature exceeds the inside temperature by more than some amount, in this case 10 degrees F., a decision is made to run the Fan. In the case where the fan is already run, the decision would be to continue running the Fan.

After the decision is made to run the Fan, data about the power subsystem is used to determine the best method of running the fans (430). As part of this process, the current state of charge of the battery is determined and the amount of power being generated by the external power source, such as a solar cell, is checked. If the unit is being run for the first time, the CCS may perform some Fan diagnostics to determine the maximum power used by the Fan. Tests may also be performed to determine the most efficient use of power.

Once data is collected about the power subsystem, a decision is made as to the speed to run the Fan (440). If the battery is fully charged and there is enough power coming into the system from the solar cells to run the fan at full power without causing a discharge of the battery, run the Fan at full speed (460).

If running the Fan at full speed would cause a drain on the battery, the CCS unit conserves power (450) by trying to find the optimal speed at which to run the fan given the current and predicted future conditions. For instance, if the CCS unit may check the weather projections. If the weather is expected to be overcast for two days and sunny on the third, the CCS unit may determine that it should reduce the fan speed to 50% in order to have power available for the following days.

Once the Fan speed has been set, the cycle restarts, and the CCS scans the sensors to see if conditions have changed.

The foregoing description of preferred embodiments of the present invention provides illustration and description, but is not intended to be exhaustive or to limit the invention to the precise form disclosed. Modifications and variations are possible in light of the above teachings or may be acquired from practice of the invention.

The foregoing description of preferred embodiments of the present invention uses the term “fan”, but this term is not intended to limit the invention to a precise form. One skilled in the art will appreciate that a fan may also be described as an air movement device. Similarly the term “battery” may also be described as a power storage device.

No element, act, or instruction used in the description of the present application should be construed as critical or essential to the invention unless explicitly described as such. Also, as used herein, the article “a” is intended to include one or more items. Where only one item is intended, the term “one” or similar language is used.

The scope of the invention is defined by the claims and their equivalents.

What is claimed:

1. An improved air circulation control device comprising:
a power delivery device; and
a power storage device; and
an environmental sensor; and
an interface for connecting to an air circulation device; and
logic and circuitry coupled to the power delivery device, the power storage device, the interface, and the environmental sensor, the logic and circuitry controlling the state of an air circulation device depending on the state of the power delivery device, the power storage device and the environmental sensor.

2. The improved air circulation control device of claim 1, wherein the power delivery device is a solar collection device.

3. The improved air circulation control device of claim 1, wherein the power delivery device is a windmill.

4. The improved air circulation control device of claim 1, further comprising:
two or more power delivery devices.

5. The improved air circulation control device of claim 4, wherein one or more power delivery devices are “off grid” and one is “on grid”.

6. The improved air circulation control device of claim 1, wherein the power storage device is a battery.

7. The improved air circulation control device of claim 1, wherein the environmental sensor is a temperature sensor.

8. The improved air circulation control device of claim 1, wherein the environmental sensor is a humidity sensor.

9. The improved air circulation control device of claim 1, further comprising:
two or more environmental sensors.

10. The improved air circulation control device of claim 1, wherein the logic and circuitry controls the voltage of the air circulation device.

11. The improved air circulation control device of claim 1, wherein the logic and circuitry vary the speed of a fan.

12. The improved air circulation control device of claim 1, further comprising an interface to an integrated fan/fan speed controller.

13. The improved air circulation control device of claim 1, wherein the logic and circuitry is optimized for geographic locations.

14. The improved air circulation control device of claim 1, further comprising a standard computer interface.

15. The improved air circulation control device of claim 14, wherein the logic and circuitry may be modified by a user.

16. The improved air circulation control device of claim 1, wherein the logic and circuitry stores such data as needed to predict future operational requirements.

17. The improved air circulation control device of claim 1, wherein the logic and circuitry control the direction of airflow.

18. The improved air circulation control device of claim 16, wherein the logic and circuitry include learning algorithms.

19. The improved air circulation control device of claim 1, further comprising an interface to a weather predicting system; wherein the logic and circuitry utilizes the information from the weather predicting system to predict future operational requirements.

20. The improved air circulation control device of claim 1, wherein the logic and circuitry may be put into different modes by a user.
